(19) United States
(12) Patent Application Publication
(10) Pub. No.: US 2011/0108013 A1
(43) Pub. Date: May 12, 2011

(54) EXHAUST GAS RECIRCULATION VALVE WITH BYPASS CAPABILITY AND METHOD

(75) Inventors: Bashar Y. Melhem, Orland Park, IL (US); Brian Tarkowski, Richmond, IL (US)

(73) Assignee: International Engine Intellectual Property Company, LLC, Warrenville, IL (US)

(21) Appl. No.: 12/614,534

(22) Filed: Nov. 9, 2009

(51) Int. Cl. F02M 25/07; F02B 47/08

(52) U.S. Cl. 123/568.12; 123/568.22

(57) ABSTRACT

Unique to this invention is the design of an Exhaust Gas Recirculation (EGR) valve with bypass capabilities. EGR valves combined with a bypass valve are expensive to design and manufacture due to their complexity and unique differences. Furthermore, the reliability of multiple components is much lower than that of the single component. During various engine operating conditions it is necessary to divert the flow of exhaust gas around the EGR cooler through the intake manifold or through the EGR cooler to lower the temperature of the exhaust gas to reduce noxious emissions. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### BACKGROUND

The present invention relates generally to engine Exhaust Gas Recirculation (EGR) systems. More specifically, the present invention relates to an EGR valve with bypass capability for an EGR system.

Exhaust gas recirculation is a known technique for reducing oxides of nitrogen in products of combustion exhausted from an internal combustion engine to the atmosphere. A typical EGR system comprises an EGR valve and a bypass valve that are controlled in accordance with engine operating conditions to regulate the amount of engine exhaust gas re-circulated into the intake flow entering the engine. The main purpose is to limit the combustion temperature, and further, to reduce the formation of oxides of nitrogen during combustion.

The EGR valve is the main emissions control component in an EGR system with a bypass valve. Conventionally, the EGR valve has a housing, which is inserted into an intake manifold pocket, and opens a small exhaust gas recirculation outlet to allow a controlled amount of engine exhaust gas flow to the engine.

The conventional EGR valve comprises at least one poppet valve having a housing with at least one inlet and at least one outlet for flow of the engine exhaust gases through the valve. A valve stem is axially moveable and has at least one valve extending perpendicularly there from. The valve has at least one valve seat on an inside surface of the housing to disengage and engage with the first and second valve portions to open and close the valve, respectively. The action of disengaging and engaging is to ensure proper sealing of the seat on the housing.

The second emissions control component in the EGR system is the bypass valve. The bypass valve is used to divert the flow of engine exhaust gas around the EGR cooler to allow for rapid warm up during combustion. Conventionally, the engine exhaust gas does not require cooling during cold engine operating conditions and low engine modes, namely low torque output.

The conventional bypass valve is a butterfly valve having a housing with at least one inlet and one outlet to flow engine exhaust gases. The butterfly valve is axially moveable about its center of mass and normally rotates 90 degrees with the horizontal. A closed butterfly valve will force the engine exhaust gas through the EGR cooler to be cooled prior to recirculating into the intake flow entering the engine. An open butterfly valve allows the flow of engine exhaust gas to bypass the cooler recirculating into the intake flow entering the engine.

The previously mentioned techniques or devices have one or more drawbacks. In general, EGR and bypass valves are very expensive and add to concerns for potential failure due to excessive fouling. There is a need for an EGR valve with bypass capability that contains fewer components, avoids unnecessary costs, and reduces the overall weight of the EGR system.

### SUMMARY OF THE INVENTION

Within the design of internal combustion engines it is advantageous to design individual systems to function as desired with minimal hardware and software. Unique to this particular invention is the design of an EGR valve with bypass capabilities. It has been noted that an EGR valve and a bypass valve, within a single system, are expensive to design and manufacture due to their complexity and unique differences. Furthermore, the reliability of multiple components is always much lower than that of the single component. During normal operation, the embodiment of the proposed invention can function as an EGR valve or as a bypass valve comprising the same characteristics as the aforementioned prior art.

The assembly comprises a housing with at least one inlet and at least two outlets to allow for the flow of engine exhaust gas to the EGR cooler or back into the engine. Additionally, the housing comprises at least one sealed wall to inhibit engine exhaust gas flow.

The assembly comprises at least two poppets, a stem, and a spring. Depending on the engine operating mode, the valve will self-seal, or self-seat, due to the engine exhaust gas pressure force over the poppets, at an interior surface of the housing to allow for the engine exhaust gas to flow accordingly.

During operation of the engine, hot engine exhaust gas flows through a housing inlet. Depending on the current engine state, in this example a hot engine mode, the valve actuator will drive the valve to the EGR cooler mode, where the at least one poppet engages to form a self-seal on the interior surface of the housing due to the pressure force of the engine exhaust gas over the poppet. To initiate the EGR cooler mode, the actuator engages and drives the poppet to form a self-seal on the interior portion of the housing. Upon engagement, the spring compresses and the stem extends perpendicularly from the seated poppet. This position of the valve will allow for the hot engine exhaust gas to flow through the EGR cooler to be cooled. Once cooled the engine exhaust gas will be re-circulated into the intake flow entering the engine.

During operation of the engine, hot engine exhaust gas flows through a housing inlet. Depending on the current engine state, in this example a cold engine mode, the valve actuator will drive the valve to the EGR bypass mode, where the at least one poppet engages to form a seal on the interior surface of the housing. To perform the normally open operation, the actuator engages and drives the poppet to form a self-seal on the interior portion of the housing due to the pressure force of the engine exhaust gas over the poppet. Upon engagement, the spring compresses and the stem extends perpendicularly from the self-seated poppet. This position of the valve will allow for the cold engine exhaust gas to bypass the EGR cooler and re-circulate with the engine exhaust gas into the intake flow entering the engine.

The previously mentioned techniques and device will provide a sound alternative to the current EGR system with a bypass valve. In general, EGR and bypass valves are very expensive and add to concerns for potential failure due to excessive coking. The EGR valve with bypass capabilities contains fewer components, avoids unnecessary costs, and reduces the overall weight of the EGR system.

### BRIEF DESCRIPTION OF THE DRAWINGS

FIG. 1—Internal Combustion Engine

FIG. 2—Current EGR System (Hot Side)

FIG. 3—Current EGR System (Cold Side)

FIG. 4—EGR System containing the embodiment of the proposed EGR Valve with Bypass Capability

FIG. 5—Closed Mode for the EGR Valve with Bypass Capability

FIG. 6—EGR Bypass Mode for the EGR Valve with Bypass Capability

FIG. 7—EGR Cooler Mode for the EGR Valve with Bypass Capability

### DETAILED DESCRIPTION OF THE INVENTION

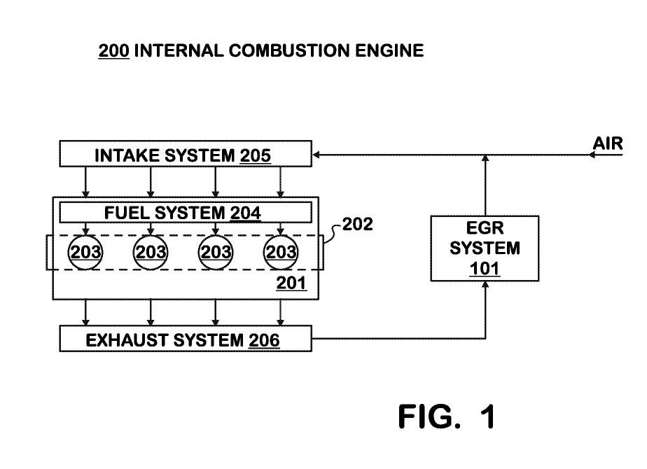

FIG. 1 shows an internal combustion engine 200 comprising a crankcase 201 housing a crankshaft 202. The crankshaft 202 delivers power to drive the cylinders 203. During a normal combustion process, the fuel system 204 provides fuel which mixes with the intake air from the intake system 205 to initiate combustion. The exhaust gases produced from the combustion process travel through an exhaust system 206. The EGR System 101 recirculates a portion of the exhaust gas back into the intake system 205 and mixes with the intake air entering the engine.

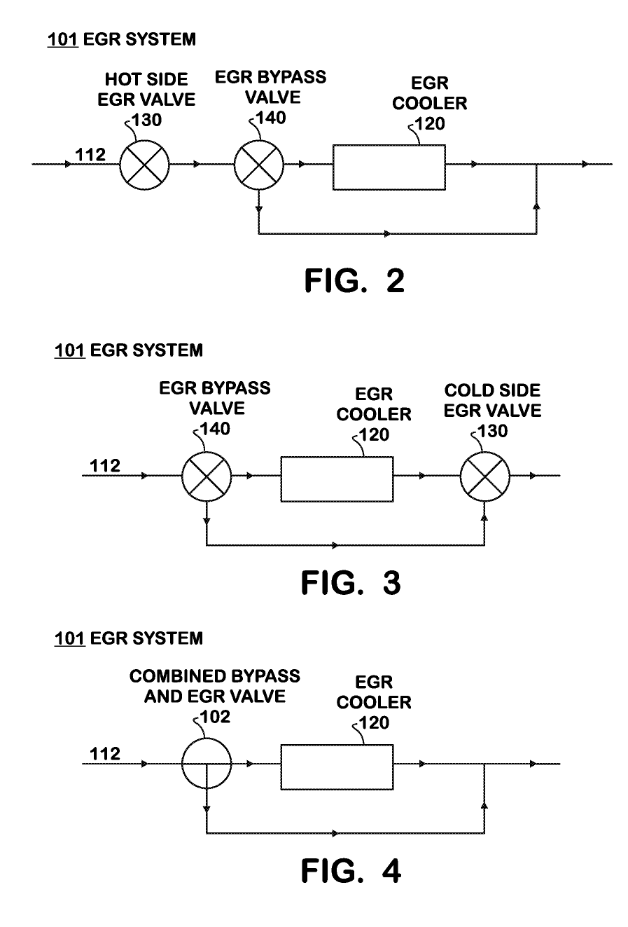

In a conventional EGR system with a bypass valve 101 there exists two configurations namely, a hot side EGR valve 130 and a bypass valve 140, as shown in FIG. 2, or a cold side EGR valve 150 and a bypass valve 140, as shown in FIG. 3. Both configurations contain an EGR cooler 120.

FIG. 2 shows the first conventional configuration of an Exhaust Gas Recirculation system with a bypass valve 101 utilized in an internal combustion engine. This EGR system 101 is normally comprised of an EGR cooler 120, a hot side EGR valve 130, and a bypass valve 140. The EGR system 101 is designed to flow the engine exhaust gas 112 through the aforementioned components.

FIG. 3 shows the second conventional configuration of an Exhaust Gas Recirculation system with a bypass valve 101 utilized in an internal combustion engine. This EGR system 101 is normally comprised of an EGR cooler 120, a cold side EGR valve 150, and a bypass valve 140. The EGR system 101 is designed to flow the engine exhaust gas 112 through the aforementioned components.

FIG. 4 shows the EGR system 101 with the embodiment of the proposed invention, the EGR valve with bypass capabilities 102. In addition to the embodiment of the proposed invention, the EGR system 101 will comprise of the EGR cooler 120 to cool the hot engine exhaust gas 112 prior to re-circulating into the intake air flow entering the engine.

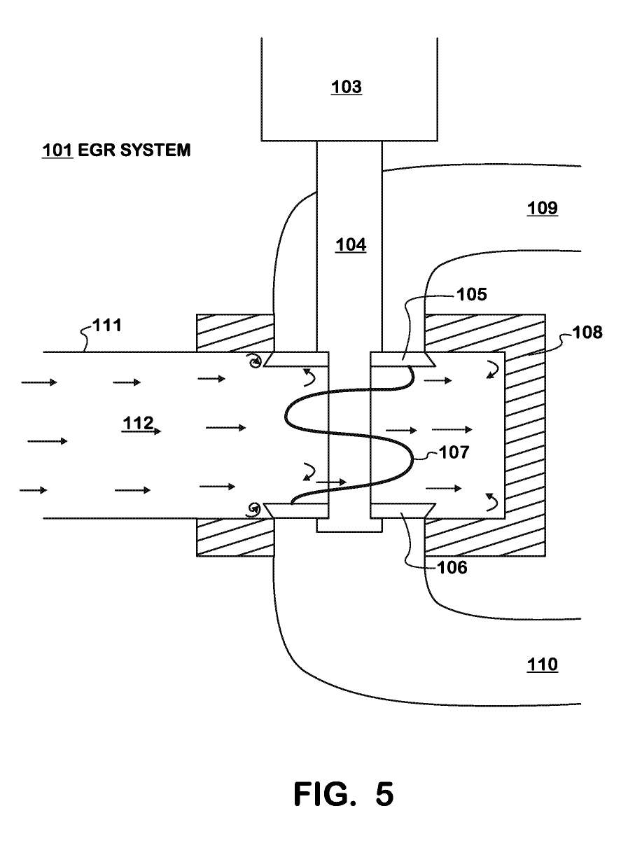

FIG. 5 shows the EGR system 101 with the embodiment of the proposed invention, the EGR valve with bypass capabilities 102. Moreover, FIG. 5 represents the Closed Mode of the embodiment of the proposed invention. The actuator 103 that provides power to drive the valve 102 is not charged therefore the engine exhaust gas 112 through the housing inlet 111 is restricted and will not flow through the EGR bypass outlet 109 or the EGR cooler outlet 110. Since the valve 102 is not powered, the poppets 105 and 106 are in physical contact with the interior surfaces of the housing 108. The poppet 105 and poppet 106 are forced to make a self-seal on the interior surface of the housing 108 due to the pressure force of the engine exhaust gas over the poppet 105 and poppet 106 with the interior surface of the housing 108.

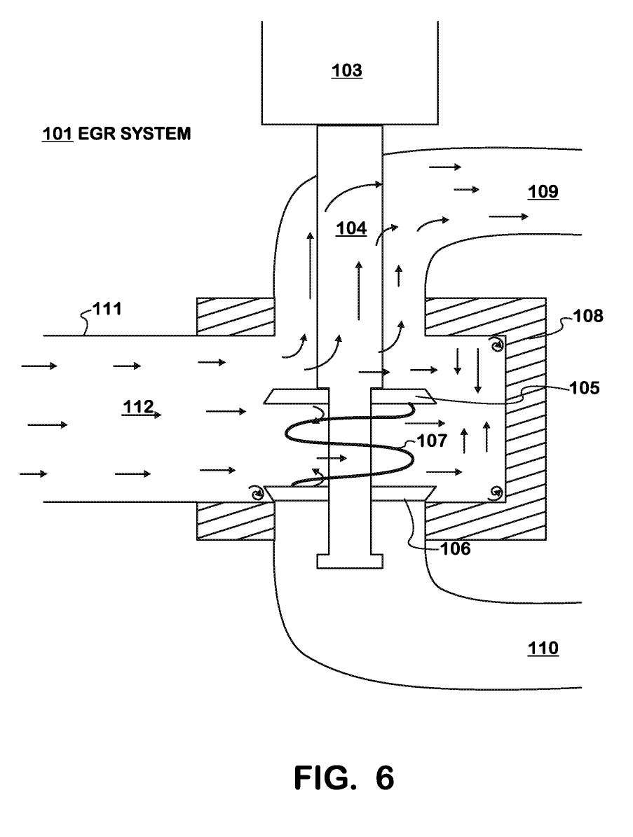

FIG. 6 shows the EGR system 101 with the embodiment of the proposed invention, the EGR valve with bypass capabilities 102. Moreover, FIG. 6 represents the EGR Bypass Mode of the invention during a hot engine mode. The actuator 103 is charged and forces a poppet 105 to compress the spring 107. The poppet 106 is forced to make a self-seal on the interior surface of the housing 108 due to the pressure force of the engine exhaust gas over the poppet 106 with the interior surface of the housing 108. Upon engagement of the poppet 106 with the interior surface of the housing 108, a stem 104 extends perpendicularly from the seated poppet 106. The poppet 106 seals the EGR cooler outlet 110 forcing the engine exhaust gas flow 112 to take the path of least resistance, flowing over the embodiment of the proposed invention to the EGR bypass outlet 109. Additionally, the engine exhaust gas flow 112 can flow around the embodiment of the proposed invention and encounter at least one closed wall of the housing 108. This position of the valve 102 will allow for the engine exhaust gas flow 112 to bypass the EGR cooler 120 and re-circulate with the engine exhaust gas 112 into the intake flow entering the engine.

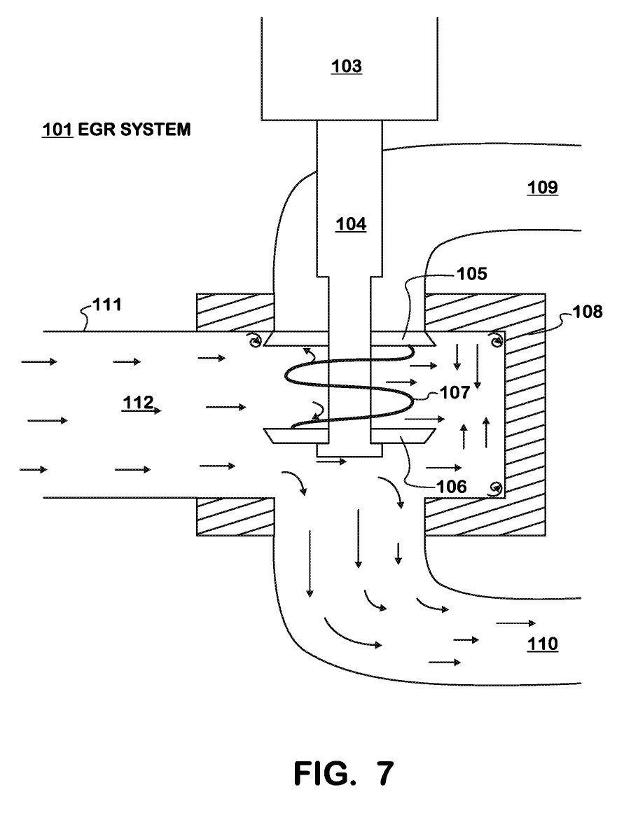

FIG. 7 shows the EGR system 101 with the embodiment of the proposed invention, the EGR valve with bypass capabilities 102. Moreover, FIG. 7 represents the EGR Cooler Mode of the invention. The actuator 103 is charged and forces a poppet 106 to compress the spring 107. The poppet 105 is forced to make a self-seal on the interior surface of the housing 108 due to the pressure force of the engine exhaust gas over the poppet 105 with the interior surface of the housing 108. Upon engagement of the poppet 105 with the interior surface of the housing 108, the stem 104 extends perpendicularly from the seated poppet 105. The poppet 105 seals the EGR bypass outlet 109 forcing the engine exhaust gas flow 112 to take the path of least resistance, flowing over the embodiment of the proposed invention to the EGR cooler outlet 110. Additionally, the engine exhaust gas flow 112 can flow around the embodiment of the proposed invention and encounter at least one closed wall of the housing 108. This position of the valve 102 will allow for the hot engine exhaust gas flow 112 to flow through EGR cooler outlet 110 to the EGR cooler 120 to be cooled. Once cooled the engine exhaust gas 112 will be re-circulated into the intake flow entering the engine.

What is claimed is:

1. An Exhaust Gas Recirculation (EGR) Valve with Bypass Capability, comprising:
a housing, said housing having at least one housing inlet, at least one EGR bypass outlet, and at least one EGR cooler outlet;
at least one stem operatively engaged to said housing, said stem having at least one circumferential dimension, said stem engaging at least one of at least two poppets;
a first of said poppets self-sealingly engaging said housing to selectively open or close said EGR bypass outlet, and a second of said poppets self-sealingly engaging said housing to selectively open or close said EGR cooler outlet;
at least one spring engaging at least one of said poppets; and
an actuator connected to said stem, said actuator operating through said stem to compress said at least one spring engaging at least one of said at least two poppets.

2. The Exhaust Gas Recirculation Valve with Bypass Capability of claim 1, wherein: said stem contains at least one dimensionally larger circumference actively engaged to at least one of said at least two poppets.

3. The Exhaust Gas Recirculation Valve with Bypass Capability of claim 1, wherein: said at least one dimensionally larger circumference of said stem is being actively engaged to at least one of said at least two poppets by the spring force of the spring being compressed.

4. The Exhaust Gas Recirculation Valve with Bypass Capability of claim 1, wherein:
said actuator is driven electronically.

5. The Exhaust Gas Recirculation Valve with Bypass Capability of claim 1, wherein:
said actuator is driven mechanically.

6. The Exhaust Gas Recirculation Valve with Bypass Capability of claim 1, wherein:
said actuator is driven pneumatically.

7. The Exhaust Gas Recirculation Valve with Bypass Capability of claim 1, wherein:
said actuator is driven hydraulically.

8. The Bypass and Exhaust Gas Recirculation Valve Assembly of claim 1, wherein:
said housing inlet is in fluid communication with the engine exhaust gas.

9. The Exhaust Gas Recirculation Valve with Bypass Capability of claim 1, wherein:
said actuator further operating through said stem to compress said at least one spring engaging at least one of said at least two poppets to open said EGR bypass outlet and close said EGR cooler outlet.

10. The Exhaust Gas Recirculation Valve with Bypass Capability of claim 1, wherein:
said actuator further operating through said stem to compress said at least one spring engaging at least one of said at least two poppets to close said EGR bypass outlet and open said EGR cooler outlet.

11. The Exhaust Gas Recirculation Valve with Bypass Capability of claim 1, wherein:
said housing having at least one wall inhibiting the flow of exhaust gas.

12. An internal combustion engine comprising;
a crankcase;
a crankshaft;
at least one cylinder within which combustion of a fuel occurs to run the engine;
an intake system delivering air to said cylinder;
a fueling system delivering fuel to said cylinder;
an exhaust system through which exhaust gas resulting from combustion within said cylinder is fluidly controlled; and
at least one Exhaust Gas Recirculation system for conveying exhaust gas from said exhaust system to said intake system to entrain some of the exhaust gas from said exhaust system with air being delivered through said intake system to said cylinder.

13. A method for controlling the exhaust flow of an engine, comprising;
providing an Exhaust Gas Recirculation (EGR) Valve with Bypass Capability, said Exhaust Gas Recirculation Valve with Bypass Capability having a housing, said housing having at least one housing inlet, at least one EGR bypass outlet, and at least one EGR cooler outlet;
said Exhaust Gas Recirculation Valve with Bypass Capability further having at least two poppets, one of said at least two poppets self-sealingly engaging said housing to selectively open or close said EGR bypass outlet;
said Exhaust Gas Recirculation Valve with Bypass Capability further having at least two poppets, one of said at least two poppets self-sealingly engaging said housing to selectively open or close said EGR cooler outlet;
said Exhaust Gas Recirculation Valve with Bypass Capability further having at least one spring engaging at least one of said at least two poppets;
said Exhaust Gas Recirculation Valve with Bypass Capability further having at least one stem having at least one circumferential dimension, said stem engaging at least one of said at least two poppets and being operatively engaged to said housing;
said Exhaust Gas Recirculation Valve with Bypass Capability further having an actuator connected to said stem, said actuator operating through said stem to compress said at least one spring engaging at least one of said at least two poppets;
opening said one of said at least two poppets self-sealingly engaging said housing to selectively open or close said EGR bypass outlet during cold ambient temperature engine starts, low engine speeds, low engine torque output and alternative desired engine states; and
opening said one of said at least two poppets self-sealingly engaging said housing to selectively open or close said EGR cooler outlet during hot ambient temperature engine starts, high engine speeds, high engine torque output and alternative desired engine states.

14. The method for controlling the exhaust flow of an engine of claim 10, wherein:
flowing the engine exhaust gas over said at least two poppets creating a pressure force producing a self-seal on the interior surface of said housing.
